(19) United States
(12) Patent Application Publication
(10) Pub. No.: US 2002/0192063 A1
(43) Pub. Date: Dec. 19, 2002

(54) Tow truck boom arranged for right angled lifting

(76) Inventor: Ronald E. Fluke JR., Norfolk, VA (US)

Correspondence Address: ANDREW M. HILL, 2101 CRYSTAL PLAZA ARC., PMB 160, ARLINGTON, VA, 22202, US

(21) Appl. No.: 09/881,723

(22) Filed: Jun. 18, 2001

(51) Int. Cl. B60P 3/12

(52) U.S. Cl. 414/563

(57) ABSTRACT

A tow vehicle such as a tow truck, adapted to obliquely approach and engage an object to be lifted. The vehicle has a boom mounted to a stable base and a swivel joint dividing the boom into a proximal section and a relatively pivotal distal section. Preferably, an orbiting electrical gearmotor fixed to the proximal section pivots the distal section by engaging a toothed rack formed as part of the distal section. Pivot is limited to a maximum of ninety degrees to the right and ninety degrees to the left by limit switches, where these directions signify deviation from longitudinal alignment of proximal and distal sections of the boom. The gearmotor is controlled by a mobile control station having manual selective pushbutton operators. The boom is hydraulically raised and lowered, and terminates in a cradle pivotally fixed thereto. The cradle has jaws which can close over the object being lifted. The tow vehicle optionally includes powered outriggers for stability.

### BACKGROUND OF THE INVENTION

1. Field of the Invention

The present invention relates to motorized tow vehicles of the type having an inclinable boom for lifting an object to be towed and a cradle for engaging the object.

2. Description of the Prior Art

Tow trucks are frequently employed to tow disabled vehicles from one location to another. In many cases, the disabled vehicle is a passenger automobile which may be initially parked in a location which prevents the tow vehicle from approaching directly from the front or rear of the disabled vehicle. It is frequently the case, for example, that a vehicle which is parallel parked against a curb between surrounding vehicles must be towed from its location.

This presents the tow truck driver with a problem. Namely, the vehicle to be towed must be sufficiently near the boom of the tow truck to be solidly engaged therewith. If direct access to the front or rear of the vehicle is obstructed by other parked cars or other obstructions, ready engagement of the vehicle to be towed becomes difficult.

The prior art has suggested modifications to tow trucks to cope with this problem. Booms of tow trucks have, for example, been provided with swiveling lifting cradles. Conventional practice with such tow trucks is to maneuver until the tow vehicle and the vehicle to be towed are perpendicularly oriented. The lifting cradle of the boom is turned on a swivel joint so that it can appropriately engage the axle of the subject vehicle. The tow truck drives away in a direction perpendicular to that of the formerly parked vehicle. This situation presents obvious hazards if the subject vehicle is parked on a frequently used street. Also, the street may possibly be too narrow to permit the tow truck to maneuver into and out of position to enable the “right angled pick-up” described above.

Other modifications to tow vehicles have been proposed. U.S. Pat. No. 4,955,777, issued to Malcolm P. Ineson on Sep. 11, 1990, shows a tow tractor having a boom which incorporates two swivel points. However, Ineson's tractor lacks a swivel located towards the center of the boom, as seen in the present invention, as well as structure for engaging wheels of a motor vehicle.

U.S. Pat. No. 3,871,535, issued to Joseph G. Fenske on Mar. 18, 1975, illustrates a tow vehicle having a pivoting boom. There is no swivel joint at the center of the boom, as seen in the present invention.

U.S. Pat. No. 5,709,522, issued to John M. Cullum on Jan. 20, 1998, shows a tow truck having two different pivot points at the crossbar of a boom. The pivot points have axes in different planes, unlike the present invention. Cullum lacks the jointed boom as seen in the present invention.

U.S. Pat. No. 4,838,754, issued to Homer J. Beliles et al. on Jun. 13, 1989, discusses maneuvering similar to that performed when lifting a motor vehicle at a right angle. The novel boom is not seen in Beliles et al.

U.S. Pat. No. 4,761,111, issued to Andrew M. Brown on Aug. 2, 1988, shows a lifting device having two pivot points wherein the axes are in the same plane. However, unlike the present invention, the pivot points are located at the vehicle engaging cradle rather than being centrally located relative to the boom.

U.S. Pat. No. 5,782,601, issued to Paul M. Wilson on Jul. 21, 1998, shows use of gears and a worm drive in a boom. There is no swivel joint at the center of the boom.

U.S. Pat. No. 4,473,334, issued to Andrew M. Brown on Sep. 25, 1984, describes local and remote controls for tow truck hydraulic systems, but fails to show a swivel joint at the center of the boom.

The prior art fails to suggest tow vehicle having a boom including a swivel joint having a vertical axis of rotation. A need remains for a tow truck which can lift one end of a motor vehicle while parked parallel to, but out of direct longitudinal alignment with, a wheeled vehicle to be towed.

None of the above inventions and patents, taken either singly or in combination, is seen to describe the instant invention as claimed.

### SUMMARY OF THE INVENTION

The present invention solves the problem of lifting a motor vehicle which has been “parked in” or otherwise obstructed from ready access to one axle for engagement lifting by a tow truck. This is accomplished by providing a swivel joint having a vertical axis of rotation in the boom of the tow truck. Because the cradle is mounted to the boom at a similar joint, orientation of the cradle and the tow truck chassis can remain parallel even when the azimuth of one section of the boom swings through an arc about the vertical axis of the joint at the center of the boom.

It is therefore possible for a tow truck incorporating the present invention to lift and tow a motor vehicle from a parallel parking situation from a location ahead or behind that vehicle, yet also to the side of the vehicle. Illustratively, a tow truck could station itself forwardly of the vehicle to be towed, and parallel to the subject vehicle in the manner of a “double parked” vehicle. Once one axle of the vehicle was secured and lifted, the tow truck could drive away starting from an orientation similar to that of passing traffic. Need for maneuvering into oncoming traffic or otherwise intruding into active driving lanes of a street is minimized or eliminated. This ability in some cases will enable a tow truck to successfully tow a vehicle in situations lacking sufficient maneuvering space for a conventional tow vehicle. Even in those situations in which a conventional vehicle could tow the subject disabled vehicle, a tow truck incorporating the novel improvements could save time, effort, and exposure to risk of hazards.

Preferably, a tow vehicle modified according to the present invention incorporates a source of power to swivel the rear section of the boom relative to the front section so that the rear section is maneuvered proximate an axle of the subject disabled vehicle. In the preferred embodiment, this is accomplished by a hydraulic gear motor powered from the conventional hydraulic system which powers the lifting function of the boom. The rear section of the boom has a toothed rack which cooperates with the gearmotor. Controls may include pushbutton controls either mounted on the tow truck body or chassis, in the cab, or may alternatively be located on a mobile, hand held control station.

Accordingly, it is one object of the invention to provide a tow vehicle which has an inclinable boom incorporating a swivel joint along the boom, and preferably towards the center of the boom.

It is another object of the invention to enable a tow vehicle to lift and tow an immobilized vehicle from an orientation parallel yet offset from the immobilized vehicle.

It is a further object of the invention to enable a tow vehicle to maneuver into proximity with an immobilized vehicle without unduly intruding into nearby traffic lanes when maneuvering into position to lift the subject vehicle and when driving away with the subject vehicle in tow.

Still another object of the invention is to enable a tow vehicle to approach an immobilized vehicle in tight quarters.

An additional object of the invention is to provide a source of power for swinging the rear section of the boom.

It is again an object of the invention to utilize an otherwise conventional hydraulic power system of a tow vehicle.

Yet another object of the invention is to provide a mobile, hand held control station to operate the power system of the boom.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental, bottom plan view of one embodiment of the invention.

FIG. 2 is an environmental, bottom plan view of the prior art.

FIG. 3 is a side elevational detail view of a vehicle shown at the upper left of FIG. 1, drawn to enlarged scale.

FIG. 4 is a bottom plan detail view of the vehicle shown at the upper left of FIG. 1, drawn to enlarged scale.

FIG. 5 is a top plan detail view of the vehicle shown at the upper left of FIG. 1, showing optional outriggers.

FIG. 6 is a diagram of power and control components of the embodiment of FIG. 1.

### DETAILED DESCRIPTION OF THE PREFERRED EMBODIMENTS

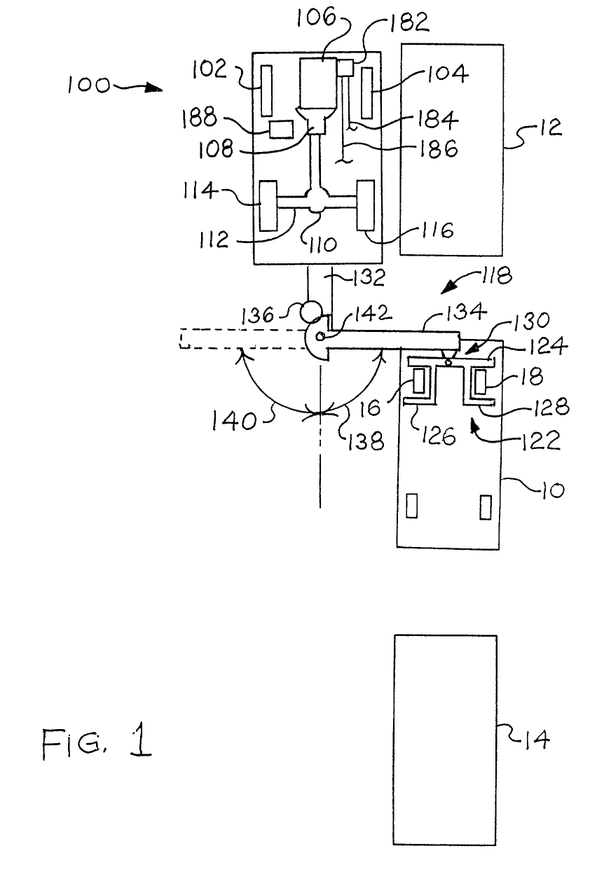

FIG. 1 of the drawings shows one embodiment of the invention wherein a tow truck 100 has approached and is lifting a disabled motor vehicle 10 to be towed. In the situation depicted in FIG. 1, motor vehicle 10 is parked parallel to a curb (not shown) between adjacent vehicles 12, 14. Tow truck 100 has approached vehicle 10 and has engaged vehicle 10 from an oblique angle. Tow truck 100 includes a conventional frame, body, or chassis to which are connected front wheels 102, 104, an engine 106, a drive train including transmission 108 and differential gear assembly 110, a rear axle 112, and driven wheels 114, 116. These elements are conventional and will not be further described herein.

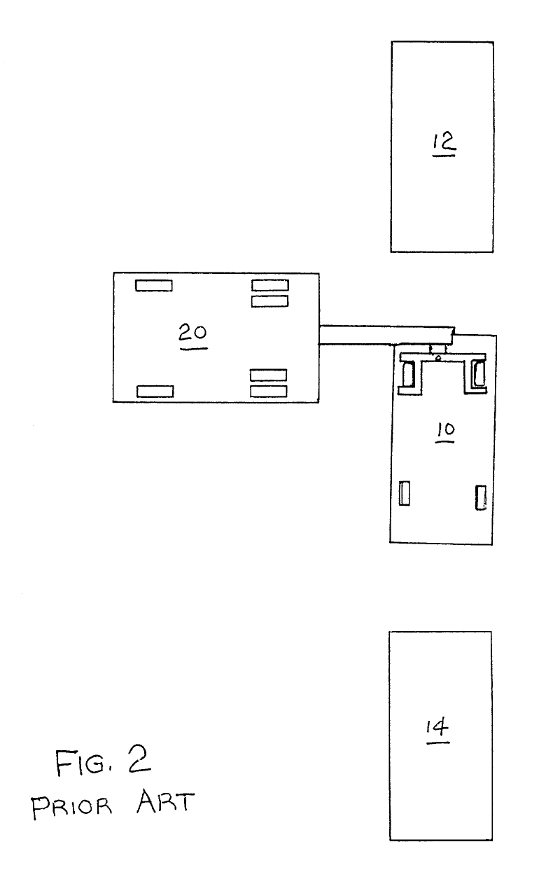

FIG. 2 shows a prior art tow truck 20 addressing a situation similar to that depicted in FIG. 1. Tow truck 20 must approach vehicle 10 at a right angle thereto, wherein the angle is defined between the longitudinal axes of vehicle 10 and tow truck 20. Although in many cases the prior art approach is operable, the present invention addresses problems arising from the orientation and proximity of tow truck 20 to vehicles 10, 12, 14. Notably, if there is insufficient space to maneuver tow truck 20 into the orientation and proximity shown in FIG. 2, or if such maneuvering would subject tow truck 20 to hazardous exposure to passing traffic (not shown) or to other hazards, then it will occasionally not be feasible to tow vehicle 10 from its parked location between vehicles 12, 14. By contrast, location and orientation of tow truck 100 in FIG. 1 are far less exposed to hazards and are less intrusive relative to the roadway than are location and orientation of tow truck 20 in FIG. 2.

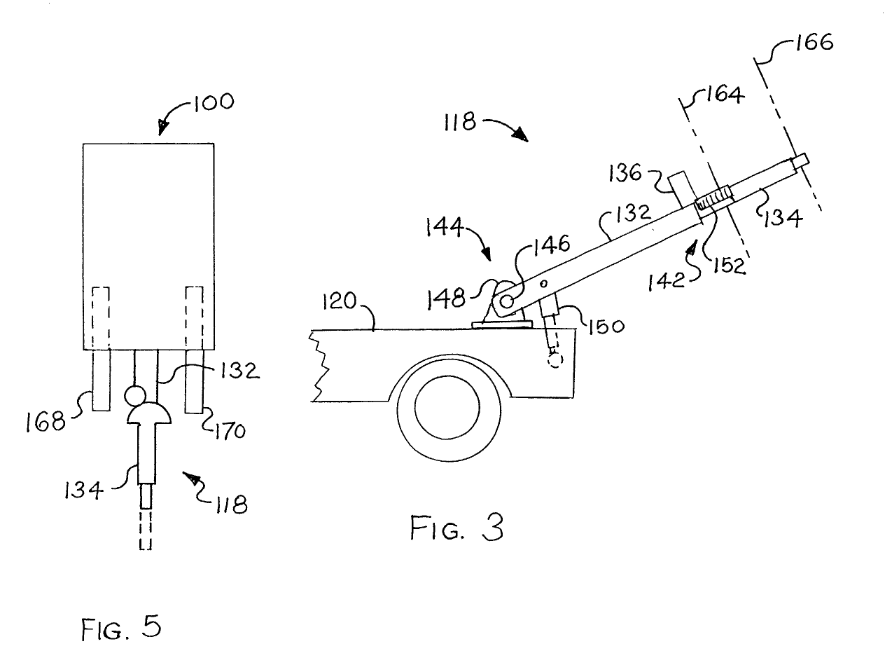

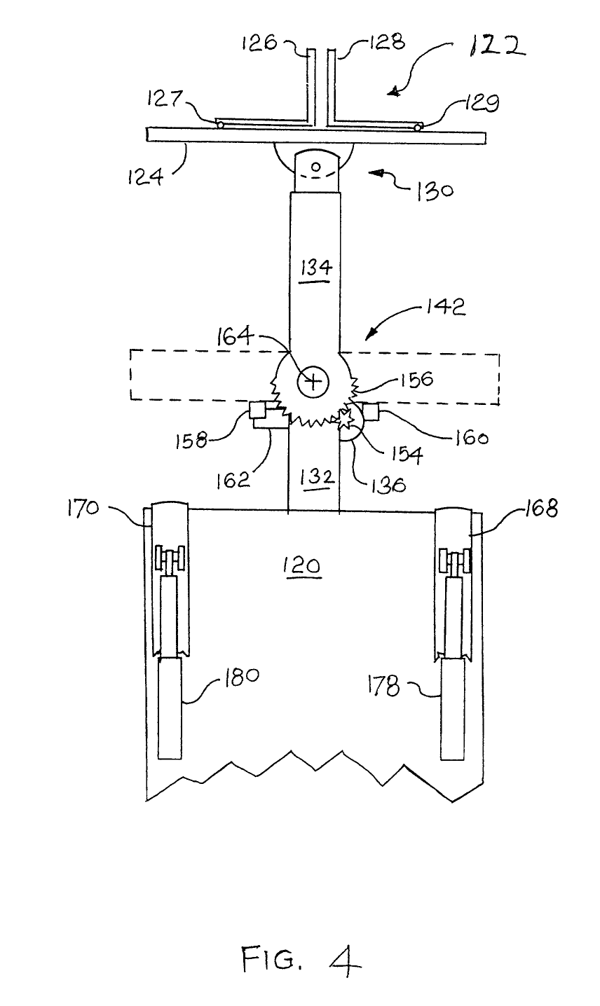

Referring primarily to FIG. 3, a boom 118 and a stable base 120 to which boom 118 is mounted and supported are fixed to the chassis of tow truck 100 either directly or indirectly in a manner assuring that boom 118 can lift, tow, and control vehicle 10. Boom 118 engages wheels 16, 18 of vehicle 10 by an engagement element. The engagement element engages the object being lifted (in the depiction of FIG. 1, this being vehicle 10) sufficiently securely to maintain grasp and control thereof while lifting and towing the same. As seen in FIG. 4, the engagement element comprises a cradle 122 of conventional nature, having a bar 124 on which are mounted jaws 126, 128. Jaws 126, 128 rotate about pins 127, 129 until they assume the orientation shown in FIG. 1, lodged against wheels 16, 18. Each wheel 16 or 18 is thus pinned between bar 124 and one jaw 126 or 128. Cradle 122 is pivotally joined at distal section 134 of boom 118 by a swivel joint 130 to assist in maneuvering to engage wheels 16, 18.

Boom 118 has novel features including proximal and distal sections 132, 134 pivotally joined by a swivel joint 142 and a gearmotor 136 for moving distal section 134 relative to proximal section 132. Range of motion of distal section 134 is indicated by arrows 138, 140. A second swivel joint 144 fixed to base 120 engages proximal section 132 of boom 118, enabling boom 118 to incline relative to base 120. Joint 144 may be, for example, a clevis joint wherein a cylindrical pin 146 secured in a clevis formed in proximal section 132 engages a stand 148 fixed to base 120. A powered actuator raises and lowers boom 118 relative to base 120. Preferably, the actuator is an extensible hydraulic cylinder assembly 150 having an enclosed cylinder (not separately shown) and a piston (not separately shown) slidably disposed within the cylinder, connected to a powered hydraulic system carried aboard tow truck 100. Hydraulic systems having extensible actuators are well known and need not be set forth in extreme detail herein.

Structure of swivel joint 142 is shown in FIGS. 3 and 4. A toothed rack 152 is fixed to distal section 134 of boom 118. Gearmotor 136 is fixed to proximal section 132 such that teeth 154 of gearmotor 136 engage teeth 156 of rack 152. Distal section 134 of boom 118 swivels about axis 164 of joint 142 when the motor (not separately shown) of gearmotor 136 rotates responsively to teeth 154 engaging and driving teeth 156 of rack 152. Maximum deviation of longitudinal orientation of distal section 134 of boom 118 is controlled by limit switches 158, 160. Switch 158 is mounted on a tab 162 fixed to proximal section 132 of boom 118, and switch 160 is mounted on gearmotor 136. Limit switches 158, 160 limit azimuthal rotation of distal section 134 to an arc spanning one hundred eighty degrees of rotation (see FIG. 1). Maximal deviation from the longitudinal alignment of proximal section 132 and distal section 134 is ninety degrees to the right of the longitudinal orientation shown in FIG. 1 and maximal deviation to the left of the same orientation is ninety degrees from longitudinal orientation.

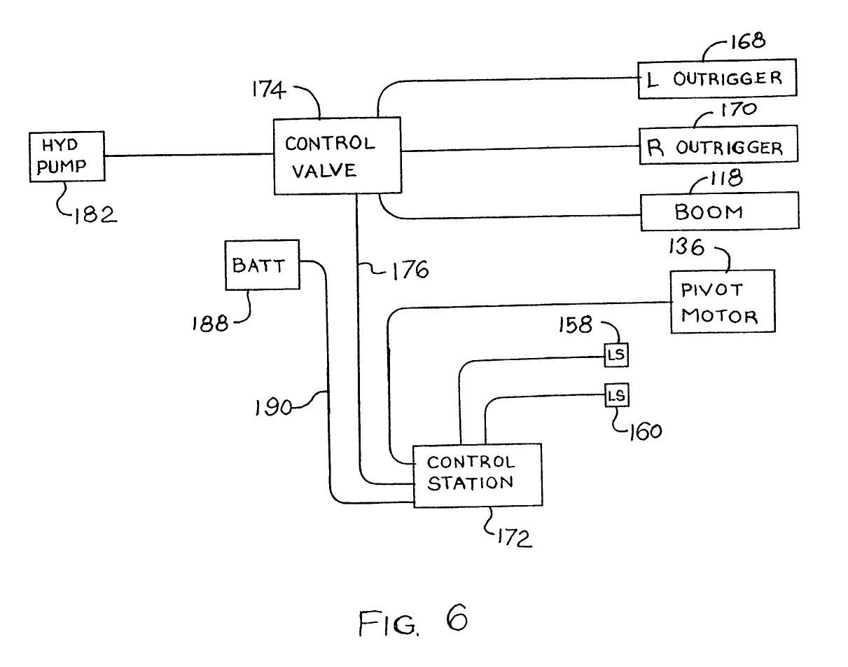

FIG. 4 also shows left and right outriggers 168, 170 which are optionally provided as part of tow truck 100. Outriggers 168, 170 are anchored to the chassis or other structural part of tow truck 100 which is fixed to base 120. Outriggers 168, 170 are disposed to project laterally from base 120 when deployed (as shown in FIG. 5) to stabilize tow truck 100 when boom 118 is fully extended and heavy loads are imposed thereon. The retracted condition of outriggers 168, 170 and longitudinal orientation of sections 132, 134 of boom 118 are shown in FIG. 4.

FIG. 3 shows relative orientation of swivel joints 130 (represented by axis of rotation 166), 142, and 144. Swivel joint 144 has an axis of rotation which is parallel to and concentric with pin 146. The axis of rotation represented by pin 146 is horizontally oriented when base 120 of tow truck 100 is horizontally oriented. Swivel joints 142, 130 have respective axes of rotation 164, 166 which are vertically oriented when sections 132, 134 of boom 118 is horizontally oriented, as it would be if lowered from the position depicted in FIG. 3.

Referring now to FIG. 6, gearmotor 136 is controlled from a mobile, hand held control station 172 connected to the electrical and hydraulic systems of tow truck 100. Control station 172 is operably connected to a control valve 174 by a control line 176. Control line 176 will be understood to include plural electrical conductors (not separately shown) and, where applicable, plural fluid conduits (not separately shown) preferably all contained within a common jacket (not separately shown).

Outriggers 168, 170 and boom 118 are operated by respective hydraulic actuators 178, 180 (see FIG. 4) and 150 (see FIG. 3). Actuators 150, 178, 180 are controlled from control valve 174, which may be, for example, one or more spool valves (not separately shown) connected to the hydraulic power system of tow truck 100. The hydraulic power system includes a hydraulic pump 182 driven by engine 106. Pump 182 is connected to a supply fluid conduit 184 (see FIG. 1) arranged to conduct hydraulic fluid under pressure from pump 182 to valve 174. Spent fluid is returned from actuators 150, 178, 180 of boom 118 and outriggers 168, 170 by a return conduit 186 (see FIG. 1).

Gearmotor 136, which is that motor causing distal section 134 of boom 118 to pivot relative to proximal section 132, is electrically operated from the electrical system of tow truck 100. The electrical system is generally conventional, having a battery 188 supplying a power circuit represented at 190. Motor 136 is operably connected to power circuit 190 by control station 172 and electrical conductor 192.

Control station 172 is arranged to rotate or swivel distal section 134 of boom 118 in one direction relative to proximal section 132, in an opposed direction relative thereto, and to cease rotation or swiveling such that a selected angular relationship of sections 132 and 134 is maintained. Control station 172 will be understood to incorporate pushbuttons or selector switches or both to accomplish the functions described herein. This is easily accomplished by applying power to motor 136 selectively in either of two available polarities and by disconnecting power from motor 136 when desired angular relationship is achieved. Limit switches 158, 160 will disconnect power, thereby overriding manual controls, at the extreme permissible limits of rotation of distal section 134 of boom 118.

Additional hydraulic system controls are provided on control station 172 to extend and retract left and right side outriggers 168 and 170, and to raise and lower boom 118. The control scheme may take any one of several forms. Fluid power circuits (not separately shown) may be routed through and directly controlled by control station 172. Alternatively, pilot hydraulic circuits may be routed through and controlled by control station 172. If pilot circuits are employed, then they will control corresponding elements such as spools (not separately shown) of control valve assembly 174.

In a further alternative, hydraulic circuits operating outriggers 168 and 170 and boom 118 may be operated indirectly by electrical control circuits operating solenoids (not separately shown) disposed within control valve assembly 174 to accomplish the desired control functions. In a similar manner, motor 136 may be controlled indirectly by a control circuit (not shown) incorporating suitable relays rather than by applying and disconnecting power directly connected to motor 136 through control station 172.

The invention is susceptible to variations and modifications which may be introduced thereto without departing from the inventive concept. For example, either or both of sections 132 and 134 of boom 118 may include telescoping extensions (not shown). Also, location of swivel joint 142 may be varied from the depicted location proximate the center of boom 118.

Further examples of variations and modifications are as follows. Gearmotor 136 may be hydraulically powered and controlled, if desired. Control station 172 may be fixed to tow truck 100 rather than being a mobile station. Control station 172 may incorporate radio frequency signals rather than being mechanically connected to tow truck 100.

The engagement element which grasps the object being lifted and towed could comprise, in place of cradle 122, a bar (not shown) having eyes and chains having connectors capable of releasably engaging the eyes. Alternatively, the engagement element could be a flexible tether terminating in a hook. If desired, the engagement element could take still other forms.

Tow truck 100 could employ front wheel drive, all wheel drive, and powered treads or tracks in place of having the drive train and wheels as depicted. While the instant invention has been presented in terms of tow truck 100, the inventive concept may be adapted to other tow vehicles, including, for example, tractors, mobile cranes, railway and industrial material handling equipment, freight loading cranes, boats, and still others (none shown).

It is to be understood that the present invention is not limited to the embodiments described above, but encompasses any and all embodiments within the scope of the following claims.

I claim:

1. Lifting apparatus for approaching and lifting an object, comprising a stable base and a boom having a proximal section mounted to said base, a distal section terminating in an engagement element disposed to engage the object, and a first swivel joint having a first axis of rotation which is vertically oriented when said boom is horizontally oriented, wherein said first swivel joint pivotally joins said proximal section of said boom to said distal section of said boom.

2. The lifting apparatus according to claim 1, wherein said engagement element is disposed to engage the object sufficiently securely to maintain grasp and control of the object while lifting and towing the object.

3. The lifting apparatus according to claim 1, further comprising a second swivel joint disposed to enable said boom to incline relative to said base, wherein said second swivel joint has a horizontal axis of rotation when said base is horizontally oriented, and an actuator fixed to said base and to said proximal section of said boom, disposed to inclinably raise and lower said boom relative to said base under power from a source of power.

4. The lifting apparatus according to claim 3, further including said source of power.

5. The lifting apparatus according to claim 3, wherein said actuator is a hydraulic actuator, and said lifting apparatus further includes a hydraulic system.

6. The lifting apparatus according to claim 5, wherein said hydraulic system is coupled to a hydraulic pump powered by a source of power, and includes a supply fluid conduit disposed to conduct hydraulic fluid from said hydraulic pump to said hydraulic actuator, and a return fluid conduit disposed to conduct spent hydraulic fluid from said hydraulic actuator to said hydraulic pump.

7. The lifting apparatus according to claim 6, wherein said hydraulic system further includes said hydraulic pump.

8. The lifting apparatus according to claim 3, further comprising a toothed rack fixed to said distal section of said boom and a gearmotor fixed to said proximal section of said boom, wherein said gearmotor includes a motor powered from a source of power, and a rotatable gear driven by said motor and disposed to engage said teeth of said rack and to cause said distal section of said boom to swivel relative to said proximal section of said boom when said motor operates.

9. The lifting apparatus according to claim 8, wherein said lifting apparatus further includes an electrical system having a power circuit, and said motor of said gearmotor is an electric motor operably connected to said power circuit.

10. The lifting apparatus according to claim 9, further including selective controls disposed to selectively rotate said distal section of said boom in a first direction relative to said proximal section, in a second direction relative to said proximal section, and to cause said distal section of said boom to maintain a selected angular relationship relative to said proximal section of said boom.

11. The lifting apparatus according to claim 10, wherein said selective controls are mounted on a mobile control station disposed in operable communication with said gearmotor.

12. The lifting apparatus according to claim 10, further comprising at least one limit switch disposed to limit azimuthal rotation of said distal section to an arc spanning one hundred eighty degrees of rotation wherein maximal deviation from a longitudinal orientation wherein said distal section of said boom is longitudinally aligned with said proximal section of said boom is ninety degrees to the right of said longitudinal orientation and maximal deviation to the left of said orientation is ninety degrees to the left of said longitudinal orientation.

13. The lifting apparatus according to claim 6, further including at least one outrigger anchored to said base and disposed to project laterally therefrom, wherein said controls include controls to deploy and retract said at least one outrigger.

14. The lifting apparatus according to claim 1, wherein said engagement element is a cradle including jaws disposed to close against the object being lifted.

15. The lifting apparatus according to claim 14, further including a third swivel joint having a third axis of rotation which is vertically oriented when said boom is horizontally oriented, wherein said third swivel joint pivotally joins said distal section of said boom to said cradle.

16. Lifting apparatus for approaching and lifting an object, comprising a stable base, an electrical system powered by a power source and having a power circuit, a hydraulic system including coupling to a hydraulic pump powered from a power source, wherein said hydraulic pump is disposed to provide hydraulic fluid under pressure, a supply fluid conduit disposed to conduct hydraulic fluid from said hydraulic pump to at least one hydraulic actuator, a return fluid conduit disposed to conduct spent hydraulic fluid from said at least one hydraulic actuator to said hydraulic pump, and at least one outrigger anchored to said base and disposed to project laterally therefrom;
a boom having
a proximal section mounted to said base, including a gearmotor fixed to said proximal section of said boom, wherein said gearmotor includes an electric motor powered from said electrical system, and a rotatable gear driven by said motor,
a distal section terminating in an engagement element disposed to engage the object being lifted, a toothed rack fixed to said distal section of said boom, wherein said rotatable gear of said gearmotor is disposed to engage said teeth of said rack and to cause said distal section of said boom to swivel relative to said proximal section of said boom when said motor operates,
a first swivel joint having a first axis of rotation which is vertically oriented when said boom is horizontally oriented, wherein said first swivel joint pivotally joins said proximal section of said boom to said distal section of said boom,
a second swivel joint disposed to enable said boom to incline relative to said base, wherein said second swivel joint has a horizontal axis of rotation when said base is horizontally oriented, a source of power,
a third swivel joint having a third axis of rotation which is vertically oriented when said boom is horizontally oriented, wherein said third swivel joint pivotally joins said distal section of said boom to said engagement element,
a hydraulic actuator fixed to said base and to said proximal section of said boom, disposed to inclinably raise and lower said boom relative to said base under power from said power source; and
a control station having selective controls disposed to selectively rotate said distal section of said boom in a first direction relative to said proximal section, in a second direction relative to said proximal section, to cause said distal section of said boom to maintain a selected angular relationship relative to said proximal section of said boom, to operate said gearmotor, and to deploy and retract said at least one outrigger,
wherein said lifting apparatus further comprises at least one limit switch disposed to limit azimuthal rotation of said distal section to an arc spanning one hundred eighty degrees of rotation wherein maximal deviation from a longitudinal orientation wherein said distal section of said boom is longitudinally aligned with said proximal section of said boom is ninety degrees to the right of said longitudinal orientation and maximal deviation to the left of said orientation is ninety degrees to the left of said longitudinal orientation.

17. The tow truck according to claim 16, wherein said engagement element is a cradle including jaws disposed to close against the object being lifted.

18. The lifting apparatus according to claim 16, further including said source of power and said hydraulic pump.

19. A tow truck for approaching and lifting a wheeled vehicle having wheels, said tow truck comprising a stable base, wheels connected to said base, an engine disposed to provide power to said wheels, an electrical system having a battery and power circuit, a hydraulic system including a hydraulic pump disposed to provide hydraulic fluid under pressure, a supply fluid conduit disposed to conduct hydraulic fluid from said hydraulic pump to at least one hydraulic actuator, and a return fluid conduit disposed to conduct spent hydraulic fluid from said at least one hydraulic actuator to said hydraulic pump, at least one outrigger anchored to said base and disposed to project laterally therefrom;
a boom having
a proximal section mounted to said base, including a gearmotor fixed to said proximal section of said boom, wherein said gearmotor includes an electric motor powered from said electrical system, and a rotatable gear driven by said motor,
a distal section terminating in an engagement element disposed to engage the wheels of the vehicle being towed, a toothed rack fixed to said distal section of said boom, wherein said rotatable gear of said gearmotor is disposed to engage said teeth of said rack and to cause said distal section of said boom to swivel relative to said proximal section of said boom when said motor operates,
a first swivel joint having a first axis of rotation which is vertically oriented when said boom is horizontally oriented, wherein said first swivel joint pivotally joins said proximal section of said boom to said distal section of said boom,
a second swivel joint disposed to enable said boom to incline relative to said base, wherein said second swivel joint has a horizontal axis of rotation when said base is horizontally oriented, a source of power,
a third swivel joint having a third axis of rotation which is vertically oriented when said boom is horizontally oriented, wherein said third swivel joint pivotally joins said distal section of said boom to said engagement element,
a hydraulic actuator fixed to said base and to said proximal section of said boom, disposed to inclinably raise and lower said boom relative to said base under power from said power source; and
a control station having selective controls disposed to selectively rotate said distal section of said boom in a first direction relative to said proximal section, in a second direction relative to said proximal section, to cause said distal section of said boom to maintain a selected angular relationship relative to said proximal section of said boom, to operate said gearmotor, and to deploy and retract said at least one outrigger,
wherein said lifting apparatus further comprises at least one limit switch disposed to limit azimuthal rotation of said distal section to an arc spanning one hundred eighty degrees of rotation wherein maximal deviation from a longitudinal orientation wherein said distal section of said boom is longitudinally aligned with said proximal section of said boom is ninety degrees to the right of said longitudinal orientation and maximal deviation to the left of said orientation is ninety degrees to the left of said longitudinal orientation.

20. The tow truck according to claim 19, wherein said engagement element is a cradle including jaws disposed to close over the wheels of the vehicle being lifted.
